(19) United States
(12) Patent Application Publication
(10) Pub. No.: US 2014/0043417 A1
(43) Pub. Date: Feb. 13, 2014

(54) DEVICE AND METHOD FOR THE PRODUCTION OF GRAVURE AND OFFSET PRINTING FORMS OR FOR PRINTING CYLINDRICAL PRINTING MATERIALS

(71) Applicant: Sheila Lorch, Chester, VA (US)

(72) Inventors: Wolfgang WUESTEN, Pellingen (DE); Erhard LORCH, Wuestenrot (DE); Sheila LORCH, Chester, VA (US)

(73) Assignee: Sheila Lorch, Chester, VA (US)

(21) Appl. No.: 14/059,276

(22) Filed: Oct. 21, 2013

Related U.S. Application Data
(63) Continuation of application No. PCT/EP2012/057282, filed on Apr. 20, 2012.

(30) Foreign Application Priority Data
Apr. 21, 2011 (DE) DE102011002229.5

(51) Int. Cl. B41M 7/00

(52) U.S. Cl. CPC B41M 7/0018
USPC 347/102

(57) ABSTRACT

A device and a method for printing the surface of a flat or cylindrical printing-image store is provided, wherein the device includes an arrangement of closely adjacent cells, a printing-image store, a coating device which is assigned to the frame, a printing device which is assigned to the frame and by way of which ink can be introduced via an inkjet print head, a drying device which is assigned to the frame and by way of which the protective layer and/or the primer which is applied to the surface of the printing-image store or the ink which is introduced into the cells or is applied to the cylindrical printing material can be dried, and a positioning device in order to move the carrier between the coating device, the drying device and the printing device and to position it there in each case in a processing position.

This nonprovisional application is a continuation of International Application No. PCT/EP2012/057282, which was filed on Apr. 20, 2012, and which claims priority to German Patent Application No. DE 10 2011 002 229.5, which was filed in Germany on Apr. 21, 2011, and which are both herein incorporated by reference.

### BACKGROUND OF THE INVENTION

1. Field of the Invention

The present invention relates to a device and a method for the production of gravure and offset printing forms or for printing cylindrical printing substrates.

2. Description of the Background Art

From EP 1 456 030 B1, a method for the production of gravure printing forms is known. The printing image store described there has cells on its surface that are arranged in a closely adjacent and screen-like fashion and are approximately uniform in shape and volume, the cells being separated from one another by bridges. The diameter of the cells lies in the thousandth of a millimeter range, such that the width of the screen lies between approximately 60 to 500 lines/cm. By the insertion of ink into these cells at selected areas by means of a conventional ink jet printing head, this known method allows the production of, in particular, binary surface-variable as well as depth- and binary surface-variable reusable gravure printing forms. This can occur in a plurality of consecutive printing steps or printing layers. In its cured state, the ink is described as illustration material. Binary surface-variable gravure printing forms result in this known method from completely filling selected cells such that these cells at the selected areas that, later in the gravure printing process, are not intended to transfer any color, are completely filled with the illustration material. The remaining cells that are not filled will, later in the gravure printing process, transfer the same volume of color onto the printing substrate. Depth- and binary surface-variable gravure printing forms result in this known method by variably filling selected cells, whereby completely filled cells and cells with variable volumes result. The latter will, later in the gravure printing process, transfer variable volumes of color onto the printing substrate while the remaining, unfilled cells will transfer the same volume of color. Ink that, upon application, is deposited on the bridges can be dried and then removed from the bridges. This can be repeated before each layer application. Optionally, the surface of the printing image store is mechanically process after the ink has dried in order to remove any excess illustration material, such that the cells filled completely with illustration material lie in a flat plane flush with the bridges. The cells that are not or only partially filled with illustration material are filled with printing color in the gravure printing process. Before applying the ink, it is possible in this known method to thinly coat the surface of the printing image store, i.e., in particular the inner walls of the cells, with a so-called protective layer. To this end, materials with a high solvent content are used whose solids are accumulated on and/or incorporated into the surface after the removal of the solvents. Particularly when ceramic printing image stores are used whose pores can be closed by the incorporation of the solids, this protective layer serves to facilitate the later removal or release of the illustration material and/or the gravure printing color from the printing image store so that it can be reused. The application of the protective layer is not absolutely necessary. The printing image store is reusable because the illustration material, after the use of the gravure printing form thus produced, can be extracted again. This occurs by means of removal, release, or dissolving with a suitable solvent or mixture of solvents and/or by a chemical that reacts with the illustration material. These processes may be physically supported.

In this method known from EP 1 456 030 B1, the insertion of the ink into the cells is problematic with regard to the complete insertion of the desired ink volume into the cells. This is due to the insufficient control over the ink flow that depends, among other things, on the surface structure of the printing image store as well as the interfacial surface tension resulting between the surface and the ink applied thereto. However, the complete insertion of the desired ink volume into the cells is important in order to produce the desired printed image in an acceptable quality in the later gravure printing process. An additional difficulty presented by this known method exists with regard to precision in the application of multiple ink layers.

### SUMMARY OF THE INVENTION

It is therefore an object of the present invention to provide a device for the production of cylindrical or flat gravure printing forms and offset printing forms that comprise an arrangement of closely adjacent cells, particularly arranged in a screen-like fashion, that are separated by bridges, or for printing on cylindrical printing substrates.

In an embodiment, provision is made for the device to comprise a stand. On the stand, a carrier, for example, a plate carrier or a roll carrier, is disposed in a movable fashion. The carrier comprises brackets for the purpose of accommodating a printing image store or a cylindrical printing substrate. The carrier may be a plate carrier that accommodates plate-shaped printing image stores. The carrier may also be a roll carrier that accommodates cylindrical printing image stores. In the device, the carrier can first be coated with a protective layer or with a primer. In selected positions, ink is applied to the printing substrate or inserted into the cells. The ink is dried. The illustration material at the selected positions that extends past the upper edges of the cells and the bridges is subsequently removed from the printing image store, such that the printing image store may be used as a gravure printing form. Alternatively, the cells not filled with ink may be filled with a hydrophilic or hydrophobic material such that the printing image store may be used in offset printing. The method and the device shall be further described in the following using the example of a cylindrical printing image store for gravure printing and cylindrical printing substrates. The roll carrier comprises bearing receptacles for mounting the axis of the cylindrical printing image store or printing substrate. In the following, the latter will also be referred to as a cylindrical substrate. The bearing receptacles may comprise a chuck into which a stub shaft of the axis may be inserted. This occurs at least on one side against a limit stop in order to adjust the cylindrical substrate in the axial direction. A coating unit is disposed on the stand by means of which a preliminary coating may be applied to the surface of the cylindrical substrate. The preliminary coating may be either a type of protective layer, for example, in order to close any pores of a ceramic printing image store surface and/or a primer.

By the addition of surface-active materials and/or initiators that lead to interactions with the ink applied thereto, the primer is able to influence and make controllable the interfacial tension and/or the fluidity of the ink. The use of such primers and suitable inks for printing on non-absorbent printing substrates in order to prevent the individually applied ink drops from running or running into one another is prior art. In the production of cylindrical or flat printing image stores by the insertion of ink into cells, an optimization of the interfacial surface tension by added suitable surface-active agents can, according to the invention, substantially improve the flow of the ink for application in the cells applied to the image stores. Advantageously, a suitable initiator, can, for example induce a polymerization or polycondensation of a corresponding ink, according to the invention, immediately after insertion and quickly reduce the fluidity thereof. This ensures that the structure of the illustration material corresponds to the desired shape. This is particularly advantageous in the case of insertion into ceramic surfaces, which are porous and therefore absorbent to a certain degree because a rapid gelling of the ink can significantly reduce the deposit of the ink into the ceramic structures. Controlling the fluidity immediately after the contact of the ink with the surface can additionally advantageously prevent the ink from running into adjacent cells and thus contribute to the improvement of printing quality in the subsequent printing process. This method step is particularly advantageous in the production of cylindrical and flat gravure printing forms as well as offset printing forms that can also be produced using this method and this device.

In addition, any material remaining on bridges or any overfilling of the cells can be more easily removed during subsequent processing of the printing image store by virtue of the controllable gelling of the ink. The primer can also lead to an increased adhesion of the illustration material in the cells which, for example, can prolong the useful life of the printing image store. Both the protective layer as well as, advantageously, the primer can also optionally initiate and/or support the later removal or dissolution of the solidified ink from the printing image store.

Moreover, a printing unit is provided on the stand with which, by means of an ink jet printing head, ink may be inserted into the cells or may be applied to the printing substrate at selected areas on the surface of the cylindrical substrate. An electrical control is provided for the printing head. Moreover, the stand comprises a drying unit by means of which the protective layer and/or the primer or the applied or inserted ink on the surface of the cylindrical substrate may be dried. Moreover, a positioning unit is provided in order to shift the carrier, i.e., the plate and/or roll carrier, between the coating unit, the drying unit, and the printing unit and, in each position, to position the carrier in a processing position. The roll carrier may comprise a rotary drive for the purpose of rotating the cylindrical substrate around its axis. The rotary drive is preferably formed by a servomotor by means of which the roll carrier may be continuously driven in a rotary fashion, in particular during coating with the protective layer and/or primer. Using the servomotor, however, a stepwise rotation of the cylindrical substrate is also possible, such that the servomotor can be rotated in predetermined angular stages, particularly during printing, such that the surface of the cylindrical substrate can be printed line by line, with the printing head moving parallel to the axis of the cylindrical substrate. The coating unit preferably comprises a spray head having a spray nozzle that runs along a guide in the axial direction of the cylindrical substrate or transversely to the shifting direction of the carrier. By means of the spray nozzle, the protective layer and/or the primer is continuously applied to the flat or cylindrical substrate. In the case of a cylindrical substrate, this preferably occurs with a continuously rotating cylindrical substrate, such that the coating is sprayed on as a helical stripe, with the feed rate of the spray head being coordinated with the rotational speed of the cylindrical substrate in such a way that the individual helixes slightly overlap at the edges. In the case of a plate-shaped substrate (printing image store), the spray nozzle moves along its guide, with the carrier holding the printing image store being held in position. The carrier is moved forward line by line, with the forward movement being coordinated with the width of the spray from the spray head in such a way that the individual spray lines overlap at the edges. The ink jet printer comprises a displacement drive by means of which it can be displaced transversely to the displacement direction of the carrier, i.e., parallel to the axis of the cylindrical printing image store or printing substrate, particularly by means of a servomotor controlled by the control unit. A heat source is assigned to the drying unit. The heat source may be formed by an infrared heater and, for example, by a dark emitter. The infrared heater is preferably designed in such a way that it is disposed in a hood following the contour of the substrate over a limited section of the circumference thereof. It is located at a short distance from the surface of the substrate. By means of the heat source, the surface of the substrate may be heated to greater than 100° C., such that the protective layer and/or the primer can be dried or the solvent in the ink can evaporate. The latter is, in particular, water. The drying times for drying the protective layer and/or the primer are approximately 20 seconds. The ink is preferably dried approximately 20 minutes long and thereby cured. The cylindrical substrate is rotated during drying. The temperature of the surface of the substrate can be measured pyrometrically in order to regulate the drying temperature. However, it is also possible to operate the heat sources with a predetermined constant output. The heat source and, in particular, the at least one infrared heater, may be assigned to a hood that can be lowered. This hood is assigned to the stand in a vertically displaceable fashion. In a refinement of the invention, the production of cylindrical gravure and offset printing forms of varying diameters as well as the printing on cylindrical printing substrates having varying diameters within one device is made possible in a particularly advantageous fashion. In this refinement of the invention, the stand comprises a frame that is preferably able formed by two guide pins. Each of the two guide pins can carry a guide rail that is C-shaped in its cross section, in which a sliding block or a sliding glide engages that is connected to a sliding bed. The sliding bed is formed by the carrier and is displaceable along the pins. Here, the axis of the cylindrical substrate is preferably disposed transversely to the displacement direction of the sliding bed. The positioning unit by means of which the sliding bed can be displaced relative to the frame is preferably formed by a geared belt or spindle drive. On each of the ends of the frame, a deflection roller or a rotary drive for a geared belt is located that extends over the entire displacement path between the two pins. Using a fastening element, the sliding bed is firmly connected to the geared belt. Sensors may be provided, with the aid of which the sliding bed can be positioned in the individual processing positions. In order to position the sliding bed in the printing unit, a mechanical stop is provided, against which a stop side of the sliding bed or the carrier strikes. By means of a permanent current feed to the geared belt or spindle drive, the carrier is held in this position in which the printing head is located at a certain distance setting from the surface of the cylindrical substrate. In order to print a plate-shaped printing image store using the printing head, the printing head may be lowered. Preferably, however, the carrier carrying the printing image store is raised. This may occur by means of a lifting mechanism that lifts the frame upon which the carrier or the sliding bed formed by the carrier is guided. The printing on the surface, in which ink is inserted or applied, occurs line by line, with the carrier being gincrementally moved forward in the case of a plate-shaped substrate (printing image store). However, it is also possible for a separate positioning unit to be provided on the carrier by means of which only the printing image store is moved line by line. In the case of a cylindrical substrate (printing image store), the cylinder is rotated farther in constant angular stages after the printing of each line. The highly precise control of the positioning unit according to the invention as well as the servomotor for rotating the cylindrical substrate in predetermined angular stages and the displacement drive of the ink jet printer allow the cylindrical substrate to be positioned in a precisely reproducible fashion relative to the printing head. This allows in a particularly advantageous fashion a repeated, precisely positioned superimposed spraying of the ink at the selected positions. The printing by means of which the ink is applied or inserted preferably occurs in multiple, preferably three, consecutive steps. Provision has also been made for more than three printing steps to be used. In such a case, the partially printed surface may be coated with an intermediate primer layer. Advantageously, the eight nozzle rows of the printing head may also be controlled in pairs and the various layers may be inserted or applied one after the other in line-by-line printing of the surface. Different chemical substances may be assigned to each nozzle pair. In this manner, it is possible to advantageously produce binary surface-variable as well as depth- and binary surface-variable gravure printing forms as well as printing forms for offset printing. Provision is also made for the surface to be dried between consecutive printing steps or after multiple consecutive printing steps. During drying, the solvent evaporates from the ink, such that only the cured illustration material remains inside the cells.

In an embodiment of the invention, provision is made for proofs to be printed using the device. To this end, the roll carrier carries an additional roll that is embodied as a suction roll. The suction roll comprises a cavity that is evacuated. The surface of this roll comprises a plurality of suction openings by means of which the medium to be printed, for example, a sheet of paper, may be sucked against the suction roll such that the sheet of paper can be gradually guided past the printing head by the rotation of the suction roll, such that the sheet of paper may be printed by means of the printing head instead of the cylindrical substrate. Delivery plates may be provided for the purpose of guiding the sheet of paper.

The printing head comprises a nozzle surface comprising a plurality of nozzles arranged in a screen-like fashion that may be controlled separately and by means of which the ink can be applied to the surface of the cylindrical substrate. The resolution of the printer when printing the printing image store essentially corresponds to the screen dimension of the cells. Because the surface of the cylindrical substrate to be printed on is convex but the nozzle bearing ink exit face of the of the printing head is flat, the ink exit face has a distance that is closest to the roll to be printed and a distance in which the printing nozzles are located somewhat farther away from the roll to be printed on. According to the invention, only the nozzles located in an area that is nearest the roll surface are used for printing. This is particularly advantageous in the case of the use of cylindrical substrates with a smaller diameter or circumference because the nozzle or ink exit face can thus be adapted thereto.

The method according to an embodiment of the invention comprises a plurality of method steps to be performed one after the other in which, in order to print a flat printing image store, the flat substrate is initially fastened to a plate carrier. In the case of a cylindrical substrate, a roll carrier is used instead of a plate carrier. Here, the cylindrical substrate is clamped onto the roll carrier. In so doing, it is held in a predetermined axial position by the bearing receptacles. Using the coating unit, the surface of the flat or cylindrical substrate may be coated in the manner described above with a protective layer and/or a primer which, for example, may contain ethanol or propanol. Subsequently, the carrier is moved to the drying unit, where the solvent of the protective layer and/or the primer, i.e., for example, ethanol or propanol, is evaporated. Drying and curing occurs by heating the printing image store or printing substrate to a drying temperature greater than 100°. Subsequently, the carrier is transported to the printing unit and fixed there in a predetermined printing position, for example, against the mechanical stop. By means of the ink jet printer, ink is then inserted or applied by printing on the surface of the flat or the cylindrical substrate line by line, the substrate being displaced by a certain distance or rotated by an angular value after each line.

However, it is also possible for a line to be printed multiple times one after the other. Alternately, the entire surface of the substrate may be printed line by line in multiple consecutive cycles, where a drying may take place between the cycles. Printing is continued long enough that the cells of the printing image store are completely filled with the illustration material at the selected points on the surface or the printing substrate has been provided with the desired printed image. The printing image store thus illustrated with the ink can be used in a gravure printing process. After the illustration material has sufficiently dried to the touch over the bridges of the printing image store, according to the invention, with the aid of a special hard metal blade in a stable mount, this excess material may be advantageously scraped off down to the level of the bridges in the spray head segment opposite the rotational direction of the cylinder. This provided mount may also be used in an additional function, with the aid of a pretreatment device approximately 60 mm in width and a simple shielding plate, for the insertion of a nano-scale protective layer for surface silication by flame pyrolysis on the printing image store. If necessary, the surface of the printing image store is subsequently processed after the final drying of the ink. This may occur in another device, for example, with the aid of a turning lathe and a special polishing head.

In order to use a printing image store thus illustrated in an offset printing process, an additional method step is required because, in offset printing, the printing and non-printing elements are located on one plane. In addition, the ink used for this purpose must have either hydrophobic or hydrophilic properties. To this end, the cells that remained empty after the complete filling of the cells with ink at selected points are filled with a hydrophilic or hydrophobic ink, depending on the properties of the ink that was originally inserted. For example, the initially inserted illustration material may be hydrophobic and the additionally inserted material may be hydrophilic, or vice versa. Then the printing roll thus illustrated may be used in an offset printing process. When inserting the second ink, it is advantageous for a protective layer and/or a primer and an ink adapted to the primer, which depending on the requirements is either hydrophobic or hydrophilic, to be used. The advantages described in the case of the insertion of the first ink come to bear here as well. The insertion of the second ink may also occur by rolling, spraying, immersion, or flow coating. Material deposited on the bridges may be removed as described in the case of the removal of the illustration material and the surface may be subsequently processed. Because, in offset printing, the printing and non-printing elements are located in one plane, an offset printing form may additionally be realized in a positive-negative method with a special printing head control in one process step. In such a case, hydrophobic ink (negative) may be applied using the specially assigned nozzle array of the printing head for the non-printing elements and, using the remaining nozzles, hydrophilic ink (positive) may be applied for the printing elements. Thus, cylindrical and therefore seamless offset printing forms may be produced. Conventional offset printing forms are not cylindrical but rather flat. This simple, cost-effective, and reproducible method for the production of offset printing forms can open the market for rotating applications, for example, decorative printing, to this printing method.

The additional method step described for use in offset printing may also be used for the reverse process known from EP 1 456 030 B1 for the production of binary surface-variable gravure printing forms. To this end, however, the two inks cannot have hydrophilic or hydrophobic properties. Rather, they must be selected in such a way that the illustration material first inserted may be released from the cells with the aid of solvents in such a way that the subsequently inserted second illustration material and its primer and/or protective layer cannot be released from the cells. Then the printing forme thus produced can be used in a gravure printing process.

After use in a gravure or offset printing process, the illustration material and primer and/or protective layer located in the cells may be physically and/or chemically released from the cells using a suitable solvent and washed out, such that the printing image store thus cleaned may be reused.

The device and method described above may, according to the invention, be used equally for the production of cylindrical as well as flat printing image stores for gravure printing and offset printing. Here, it is advantageous for the device to comprise a fixed base unit and modules that are exchangeable or removable. The module for holding and positioning cylindrical substrates may, to this end, be exchanged for a module for holding and positioning flat substrates. The printer module having the ink jet head for inserting the ink in the cells remains, while the modules for pretreating or precoating and for drying the substrate may be removed. In the production of flat printing forms, these two method steps can be conducted outside of the device.

The cylindrical or flat printing image stores may comprise a metal core or layer. Such a core or layer may be made of steel or aluminum and be provided with a ceramic layer with a thickness of approximately 100 to >300 μm. The surface of this layer forms the cells separated by bridges. In accordance with the prior art, preferably metal or plastic sleeves having a ceramic top layer may also be used for the cylindrical printing image store.

The invention further relates to a refinement of the method disclosed by EP 1 456 030 B1 in which, before the insertion of the ink into the cells, the surface of the cells is pretreated. According to the invention, this occurs with the use of a primer that improves the full insertion of the ink into the cells. In addition, the primer reduces the running of ink into other, particularly adjacent, cells. In the case of ceramic substrates, the penetration of ink into the pores of the ceramic is also prevented. Moreover, the primer contributes to the ink hardening in the desired distribution as an illustration material. As a result of this precoating of a gravure printing forme or an offset printing forme, primarily binary surface-variable as well as depth- and binary surface-variable gravure printing forms and offset printing forms may be produced. In a refinement of the invention, provision is made, in the case of a multi-layer insertion of the ink, for intermediate primer layers to also be applied to ink layers that have already dried. These intermediate primer layers contribute to the ink hardening to form an illustration material in the desired shape and in the desired position. Preferably, the primer is used on non-absorbent as well as absorbent substrates such as, for example, ceramic. The use of the primer occurs on cylindrical or plate-shaped printing image stores to an equal degree. In the case of offset printing forms, it is particularly advantageous for cylindrical, seamlessly illustrated offset printing forms are produced. The primer is preferably applied by spraying or projection. However, it may also be applied using other suitable coating methods such as, for example, on doctors or rollers. However, it is also possible for the printing image store to be dipped in a primer liquid. In this manner, the primer is inserted into the cells and applied to the bridges. Moreover, a suitable surface-active agent and/or an initiator may be added to the primer. As a result of the coating with the primer, the fluidity and drying of the ink is controllable. Any material remaining on the bridges or an overfilling of the cells may be removed more simply in subsequent processing of the printing image store. The primer may optionally initiate and/or support the later dissolution or removal of the solidified ink from the printing image store. The primer is removed again after the printing process in gravure printing or offset printing along with the illustration material. This may occur using the same measures, for example, using suitable solvents or application of temperature. Preferably, the primer known under the trade name Teutanol is used. This primer is essentially ethanol with a small addition of butanone. However, another alcohol or an alcoholic solution may also be considered as a primer.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1a is a perspective view with highly enlarged cells, a cylindrical printing image store as an example of a cylindrical substrate;

FIG. 1b is a perspective view with highly enlarged cells, a flat printing image store as an example of a flat substrate;

FIG. 2 is a section according to the line II-II in FIG. 1;

FIG. 3 is a section along the section line according to FIG. 2, but with an ink-coated section 6;

FIG. 4 is a depiction according to FIG. 3 after the removal of the projecting illustration material, which is shown in the figure in dashed and double-dotted lines;

FIG. 5 is an enlarged section of a cross-section for the purpose of illustrating a three-layer ink layer;

FIG. 6 is a depiction according to FIG. 5 for the purpose of illustrating a five-layer ink layer with an intermediate primer layer;

FIG. 7 is a side view of a first exemplary embodiment of a device comprising a coating unit, a printing unit, and a drying unit;

FIG. 8 is a depiction of the coating unit in the viewing direction of the arrow VIII in FIG. 7;

FIG. 9 is a depiction of the drying unit with the hood in the raised position in the viewing direction of the arrow VIII in FIG. 7;

FIG. 10 is a depiction according to FIG. 9 with the hood in the lowered position;

FIG. 11 is a depiction according to FIG. 7 with the hood in the lowered position;

FIG. 12 is a depiction according to FIG. 7 with a roll carrier transferred to the printing unit;

FIG. 13 is a view of the printing unit in the direction of arrow VIII in FIG. 7;

FIG. 14 a principle illustration of a roll carried by a roll carrier;

FIG. 15 is a schematic view of the ink exit nozzles of the printing head used to print the surface of the roll;

FIG. 16 is a depiction of a printing unit for printing proof sheets;

FIG. 17 is a side view of a second exemplary embodiment of a device for printing a flat printing image store;

FIG. 18 is a depiction according to FIG. 17, but with the frame in the raised position;

FIG. 19 is a depiction according to FIG. 18, with the carrier located below the printing unit; and

FIG. 20 is a side view of the coating unit of a third exemplary embodiment of the invention.

### DETAILED DESCRIPTION

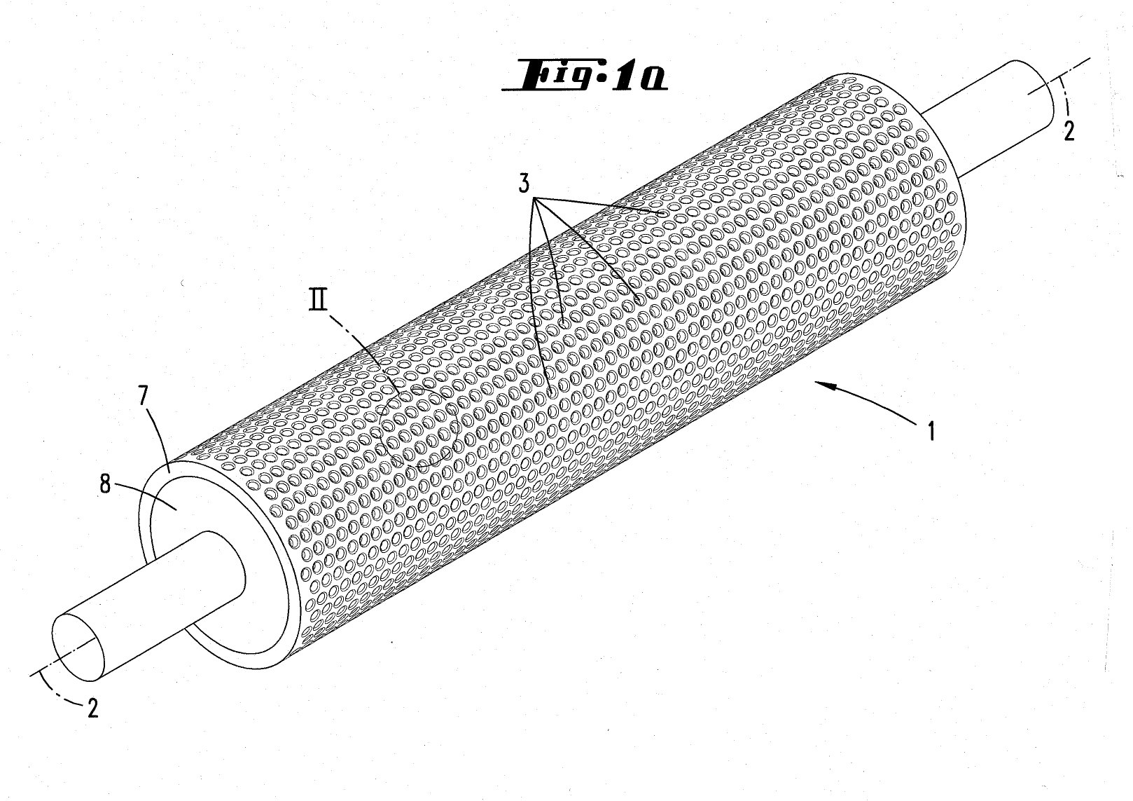

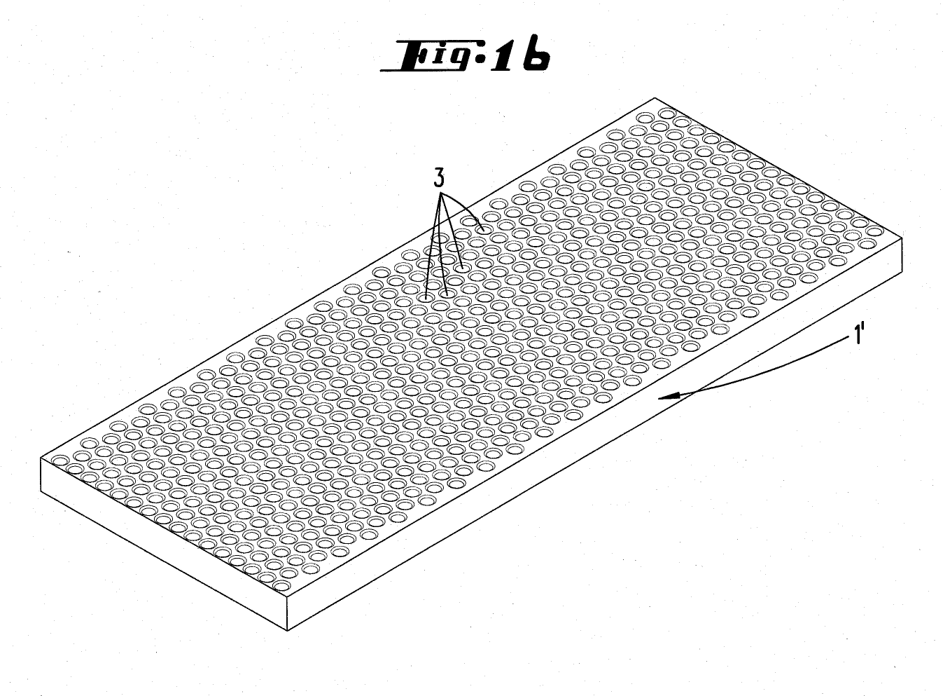

The cylinder shown in FIG. 1a with highly enlarged cells 3 forms a printing image store 1 the printing image store 1 comprises a metal core 8, for example, made of steel or aluminum, that is surrounded by a ceramic layer 7. The ceramic layer 7 forms the upper layer of the cylinder 1, which is provided on its surface with a plurality of cells 3 arranged in a screen-like fashion. The cells 3 may be disposed in a regular arrangement, for example, forming a hexagon or forming other geometric shapes. However, provision is also made for the cells to be randomly distributed over the surface in a closely adjacent fashion.

The distance a between adjacent bridges preferably lies in the range of 20 μm to 180 μm.

FIG. 1b shows a differently structured printing image store 1′. There, the printing image store 1′ is embodied as a plate. Here as well, the cells 3 are shown in a highly enlarged fashion. The printing image store 1′ comprises a ceramic surface that forms the cells 3. The ceramic surface may be applied to a metal core here as well that is made of, for example, steel or aluminum. The cells 3 may be structured and arranged as described above.

Compared to a printing plate, the cylindrical printing image store 1 according to the invention provides the advantage in offset printing of being able to print in a seamless fashion.

FIG. 2 shows the cylinder as an unillustrated printing image store. The cells 3 having a circular cross section are empty.

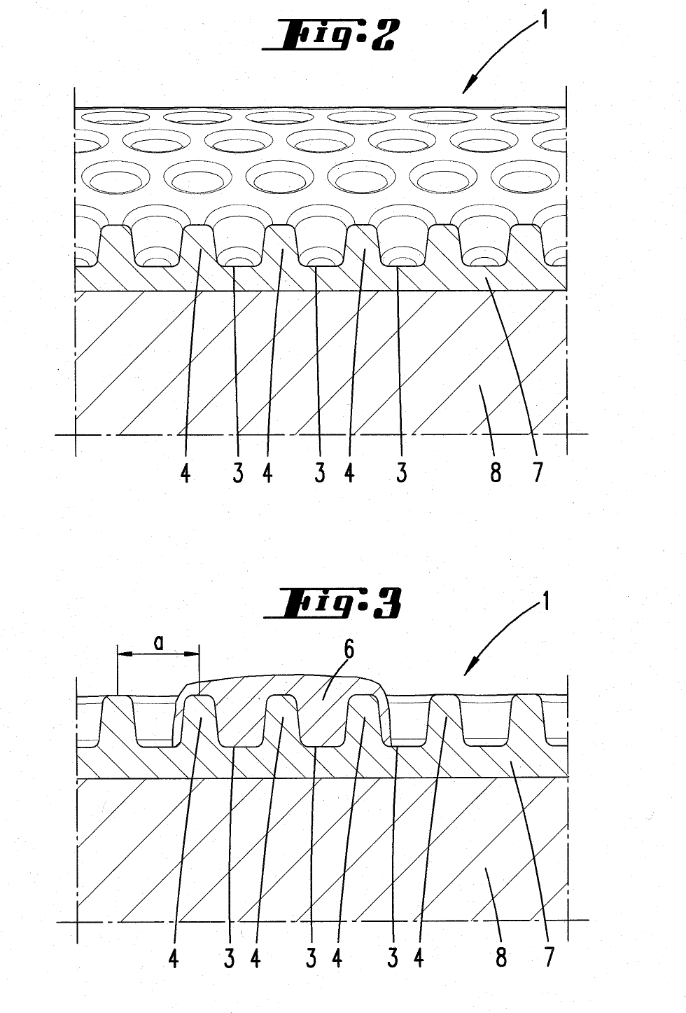

As discussed further above, the surface of the printing image store 1, 1′ is printed at selected points with a liquid filler material, which shall be referred to in the following as ink, whereby ink is inserted into the cells. This occurs in multiple consecutive steps using a printing head 25 to be described below such that the cells 3 are, as shown in FIG. 3, completely or partially filled at the selected points with cured ink 6, which is referred to as illustration material. Here, the illustration material 6 extends past the faces of the bridges 4. Between the cells 3 that are completely filled with illustration material 6 extend partially filled cells 3 and regions of cells that are not filled with illustration material. Cells that are partially filled and not filled form the imaging regions of the printing image store which, in a later printing process in which the printing image store 1, 1′ is to be used, are able to accommodate printing ink such that paper rolls or the like can be printed in a gravure printing process. Because the cells 3 that are filled with cured illustration material 6 have a protrusion, the surface of the printing image store 1 is removed in a separate method step, for example, peeled off and/or polished, with the protruding illustration material 6 being removed such that illustration material located on the surfaces of the bridges and in the cells are on a plane with the completely filled cells. This plane is thus the polishing limit 9 (see FIG. 4). The scraping off may advantageously also occur before the complete hardening of the ink, when it is sufficiently dry to the touch.

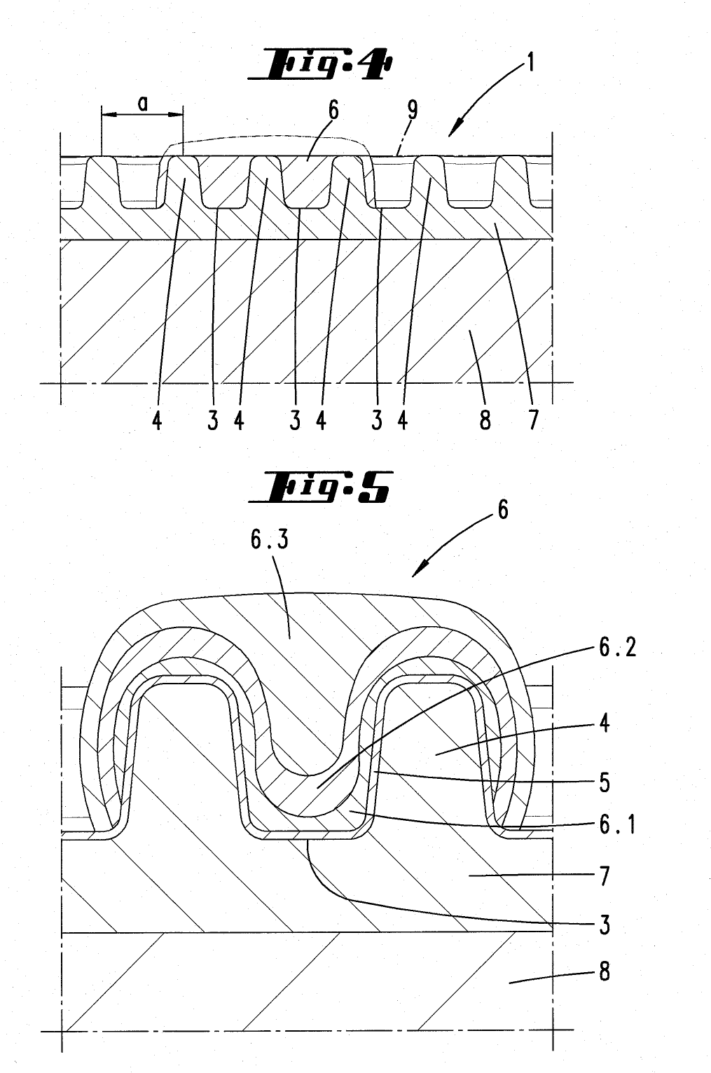

The printing process for filling the cells 3 with a solid may occur in a plurality of consecutive steps. As may be seen from FIG. 5, a protective layer and/or a primer layer 5 may first be applied to the entire surface of the printing image store 1, 1′. This means that the surface of all cells 3 is coated with a protective layer and/or a primer layer 5. After the protective layer and/or the primer 5 has dried, the printing head 25 mentioned above is used to apply a first ink layer 6.1 to the protective layer and/or the primer 5. After the first ink layer 6.1 has dried, optionally after a heat-treatment step, a second ink layer 6.2 and then a third ink layer 6.3 is applied. In the production of depth- and binary surface-variable gravure printing forms, the partially filled cells are filled, for example, with one or two such ink layers.

In an alternative to the method, which is shown in FIG. 6, an intermediate primer layer 5′ is applied to the third ink layer 6.3. On this intermediate primer layer 5′, additional ink layers 6.4 and 6.5 can then be applied. The ink layers 6.1 to 6.5 are thinly applied with an ink printing head. After a given ink layer has dried, the next layer or the intermediate primer layer 5′ is applied. In the production of depth- and binary surface-variable gravure printing forms, the partially filled cells are, for example, filled with one to four such ink layers and the respective intermediate primer layers.

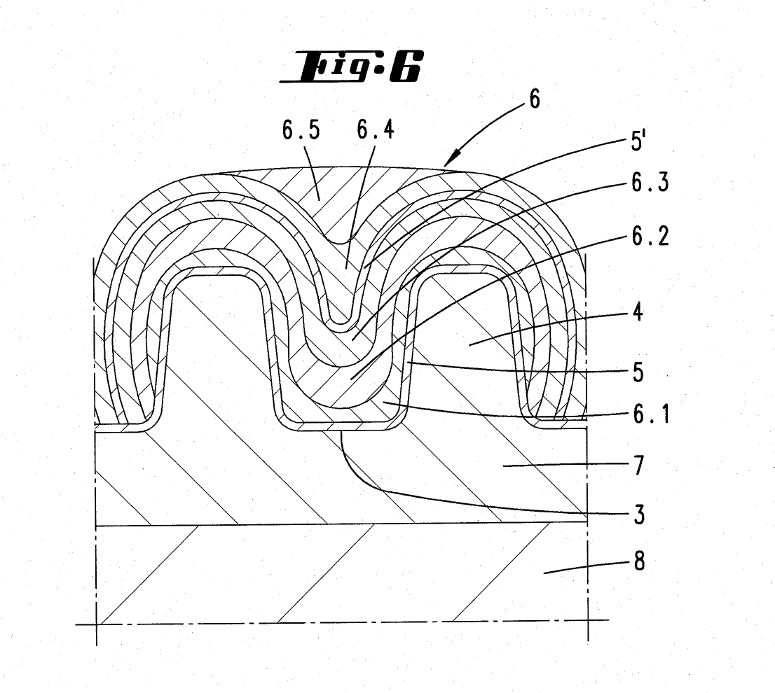

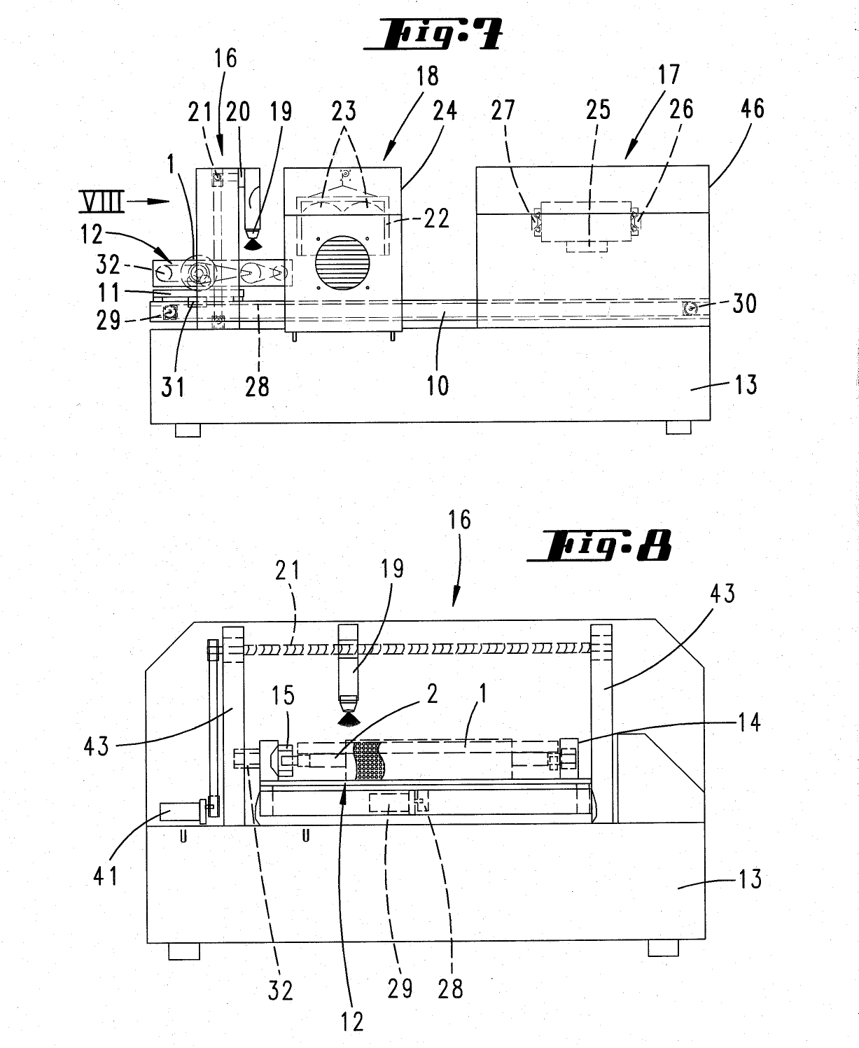

The device according to the invention is shown schematically from the side in FIG. 7. The device comprises a machine stand 13 to which a frame 10 is attached. The stand 13 carries a coating unit 16, a drying unit 18, and a printing unit 17.

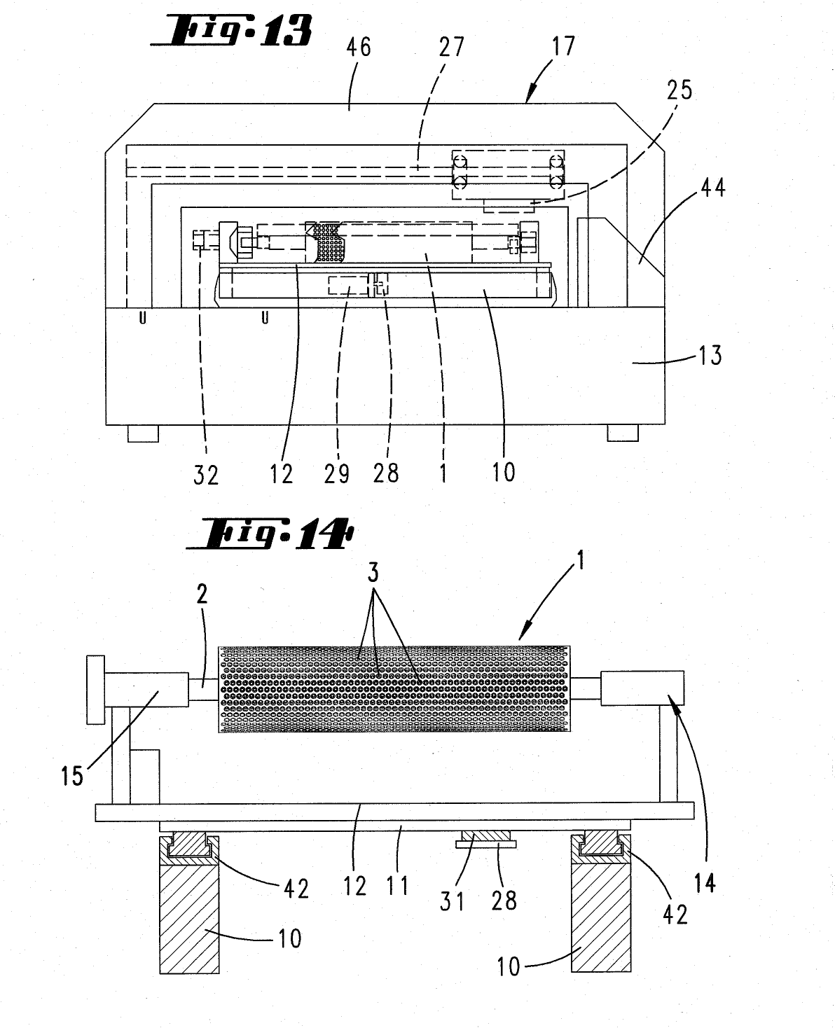

The coating unit 16, the printing unit 17, and the drying unit 18 are embodied as portals such that a roll carrier 12 or a plate carrier that is carried by a sliding bed 11 can be shifted while guided on the frame 10 through the coating unit 16, the drying unit 18, up to the printing unit 17. In order to be able to shift the sliding bed 11 along the frame 10 formed by two pins, for example a geared belt 28 is provided that runs approximately in the middle between the two longitudinal pins. On the two end pins of the frame 10 is located on one side a deflection roller 20 and, on the other side, a drive motor 29 in order to move the geared belt 28 and in order to position the sliding bed 11 at the individual processing stations. The stand 13 further carries an operator panel 44 having an electronic control. FIG. 14 shows an example of how the sliding bed 11, which carries a roll carrier 12, can be guided on the frame 10. Here, the frame 10 or its longitudinal pins carries a C-shaped rail 42 in which sliding blocks engage that are fastened to the bottom of the sliding bed 11.

The roll carrier 12 carries a bearing receptacle 14 and a liner 15. The bearing receptacle 14 and the liner 15 serve to accommodate the two stub shafts 2 of the cylindrical substrate 1. The liner 15 may comprise an axial stop such that the cylindrical substrate 1 to be printed has a define axial position. The roll carrier 12 moreover forms a rotary drive motor 32 in the form of a servomotor by means of which the cylindrical substrate 1 may be rotated continuously or in stages. The drive may occur via a geared belt here as well.

The coating unit 16 constitutes a portal formed by two carriers 43. Between the two carriers 43 runs a guide 20 and a threaded spindle 21 that protrudes through a spindle nut of a spray head carrier 43. The spray head carrier 43 carries a spray head 19 by means of which the protective layer and/or the primer may be applied to the cylindrical substrate 1. The spindle 21 is rotated by a drive motor 41, which causes the spray head 19 to move along the guide 20 transversely to the direction of extension of the frame 10 and parallel to the axis 2 of the printing cylinder 1. During its movement, a protective layer and/or a primer is emitted from the spray head 10, which is sprayed onto the rotating cylindrical substrate 1. The speed of linear motion of the spray head 19 parallel to the axis 2 is coordinated with the rotational speed of the cylindrical substrate 1 in such a way that helical spray paths are formed on the surface of the cylindrical substrate 1 that overlap on their edges.

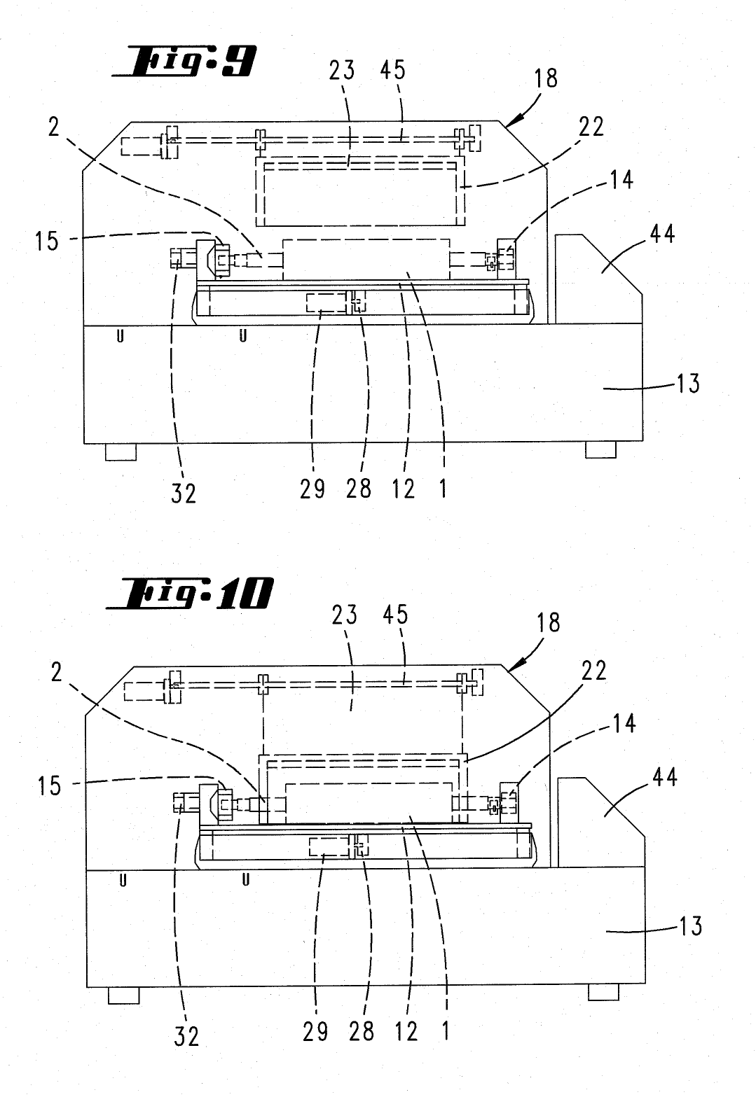

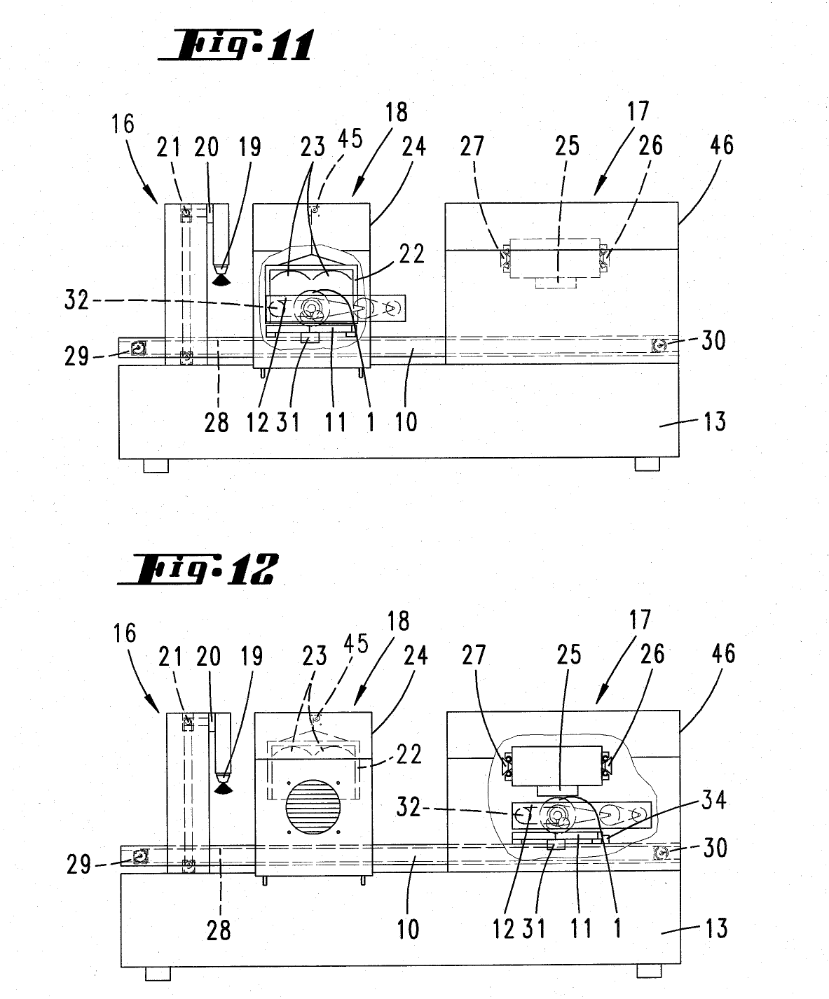

After the application of the protective layer and/or the primer on the surface of the cylindrical substrate 1, the sliding block 11 carrying the roll carrier 12 is then moved to the drying unit 18. This occurs with the aid of the geared belt 28 driven by the drive motor 29. The drying unit 18 comprises a hood 22, which may be lowered from its position as shown in FIG. 9 to the position shown in FIG. 10 over the substrate 1 to be dried. To this end, the hood hangs on a shaft 45 with cables.

Inside the hood 22 are located two infrared heaters 23 that are for example dark emitters and by means of which the cylindrical substrate 1 may be heated to a drying temperature. This may occur while the substrate 1 is rotating. The drying temperature is greater than 100° C.

After drying the cylindrical substrate 1, it is transported by the sliding bed 11 to the printing station 17. There, the sliding bed 11 hits a mechanical stop 34, such that the cylindrical substrate 1 is positioned in a reproducible fashion relative to a printing head 25.

The printing head 25 is an ink jet printing head and is moved along two guides 26, 27 extending transverse to the movement direction of the sliding bed 11. The movement direction of the printing head 25 lies parallel to the axis 2. A servomotor is provided by means of which the printing head 25 can be pushed along the guide rails 26, 27. In this manner, the printing head 25 may be used to print the surface of the cylindrical substrate 1 line by line. With the aid of the drive motor 32, the cylindrical substrate 1 is gradually rotated further and then, as described at the outset, printed on selected surfaces such that areas of the surfaces result that are completely or partially filled with illustration material 6.

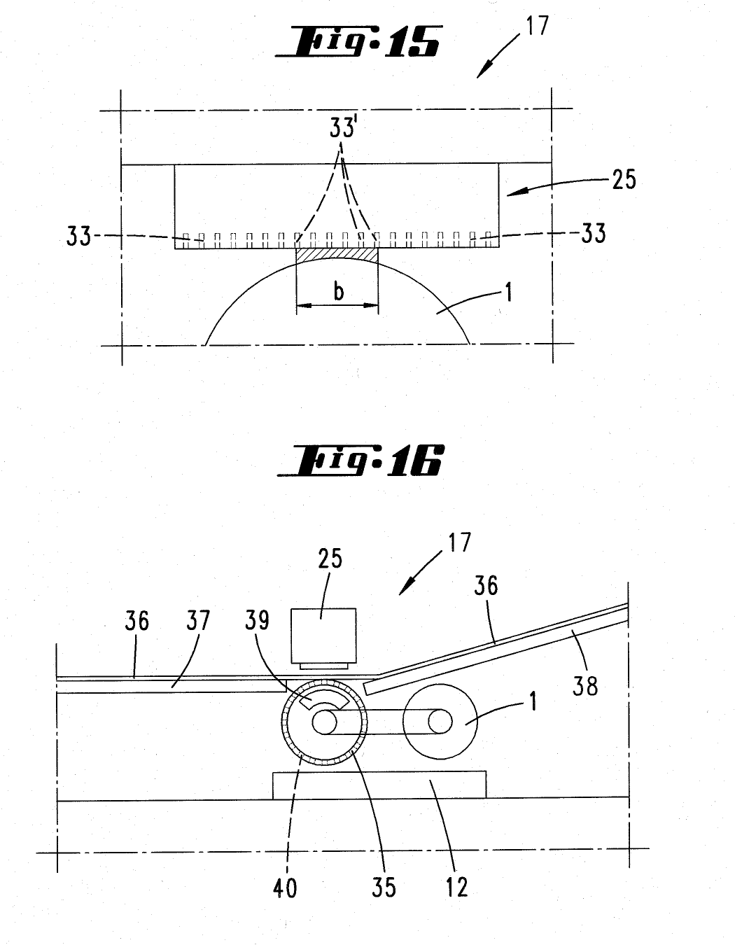

FIG. 15 illustrates the control of the ink exit nozzles 33, 33′. The ink exists only through the exit nozzles 33′, which are located in a region b that is located directly in the region of the zenith of the cylindrical substrate 1, i.e., disposed nearest to the surface of the cylindrical substrate 1.

FIG. 16 describes a variant in which, in addition to the cylindrical substrate 1 or instead of a cylindrical substrate 1, a suction roll 35 provided with holes 40 is carried by the roll carrier 12. A vacuum is generated in a cavity 30 of the suction roll 35, such that the suction roll 35 is able to transport a sheet of paper 36 along underneath the printing head 25. Again, this as well occurs in stages, with the sheet 36 to be printed being supported on delivery plates 37, 38. In this manner, a proof may be printed before printing the cylindrical substrate 1.

The illustration material 6 may be dissolved using a suitable solvent, such that the printing image store 1, 1′ may be freed of illustration material again after its use as a gravure printing cylinder and/or plate or offset cylinder. Such a printing image store 1, 1′ that has then been returned to the original condition as shown in FIG. 1 may be illustrated again with a printed image, which may occur in the manner described above. Here, in particular, provision is made for the printing image store 1, 1′ to be subjected to an intermediate drying in the drying unit 18 between two consecutive printing steps such that the ink inserted into the cells 3 can dry. The fluid portion of the ink 6 evaporates and hardened illustration material remains in the cells 3. Depending on the solid portion in the ink, multiple printing steps may also occur one directly after the other. Preferably, however, the printing image store 1 is dried between two printing layers.

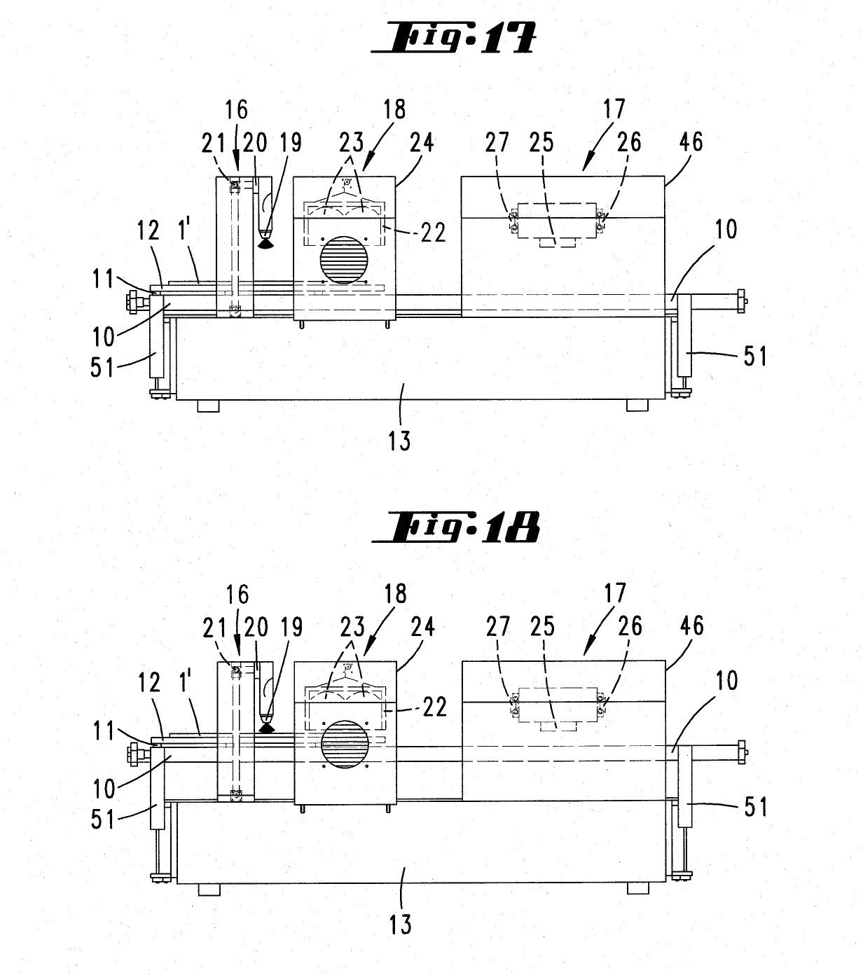

FIG. 17, like FIG. 7 described above, shows an additional exemplary embodiment of a device according to the invention in a schematic side view. On the machine stand 13, a frame 10 is attached. The stand 13 also carries a coating unit 16, a drying unit 18, and a printing unit 17. In contrast to the device 7 described above, which is provided for printing a cylindrical printing image store 1, the device shown in FIGS. 17 to 19 is provided for printing flat printing image stores 1′ as is shown, for example, in FIG. 1b. To this end, the frame 10 may be brought into a raised position with the aid of a lifting unit 51.

The lifting units 51, which are located on both ends of the frame 10, comprise a rotary-driven spindle by means of which the frame may be lifted into a position in which the printing image store 1′ lies directly below the printing head 25 of the printing unit 17, such that its cells may be filled with ink at selected positions. The hood 22 of the drying unit 18 is structured differently here than in the exemplary embodiment described above. If the area formed by the drying unit 18 is smaller than the area of the printing image store 1′ to be dried, then the carrier 12, which is embodied here as a sliding bed 11, is able to move back and forth below the drying unit 18 during the drying process.

The coating of the printing image store 1′ occurs line by line here as well, with the spray head 19 being moved back and forth along a guide. Here, the printing image store 1′ is moved forward by moving the sliding bed 11 along the frame.

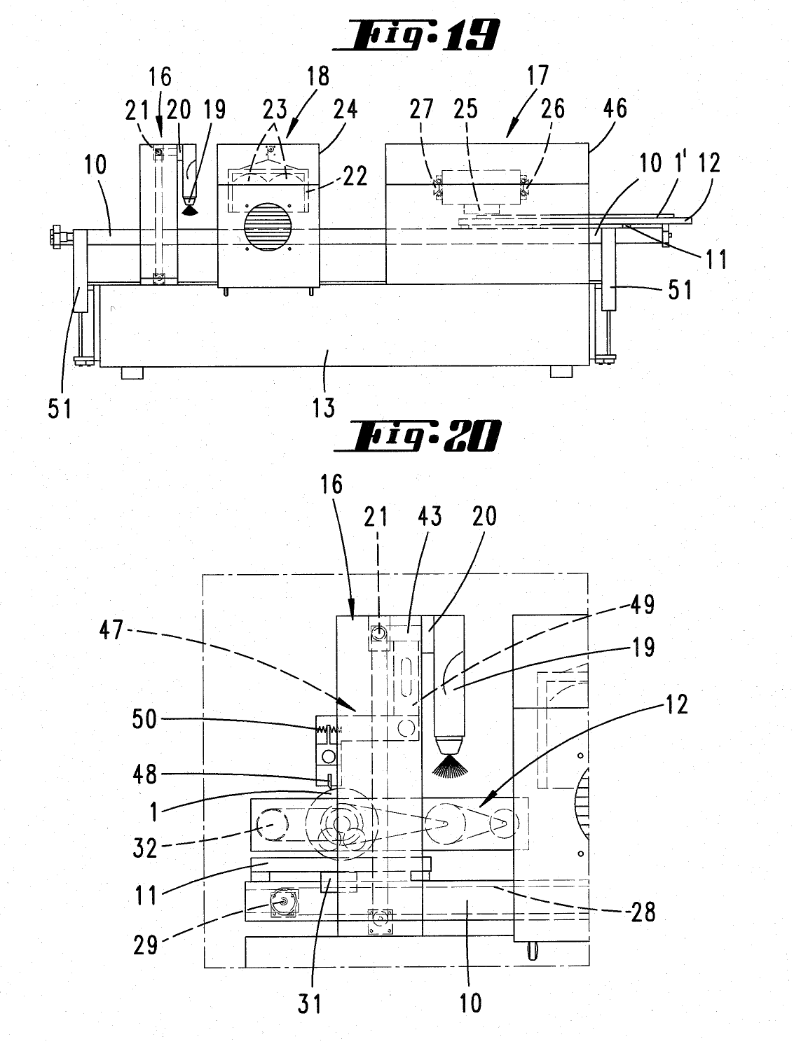

The printing, which is shown schematically in FIG. 19, also occurs line by line, with the printing image store being moved forward via the geared belt drive, by means of which the sliding bed 11 can be displaced relative to the frame 10.

Here as well, it is possible to fill the cells completely with ink at the selected points, such that only the cells 3 that are not filled are able to accommodate ink in a gravure printing process. However, it is also possible to fill some cells 3 only partially with ink such that these cells 3 receive a reduced volume and are able to accommodate a smaller amount of ink in a gravure printing process.

Moreover, it is possible, after the removal of the protruding dried ink, to fill the cells 3 that are not filled with another, for example, hydrophobic or hydrophilic material, such that the printing plate 1′ is suitable for offset printing. However, filling the cells 3 with different inks can also be realized in one process step. In such a case, the removal of the protruding dried ink occurs after printing with the hydrophobic and hydrophilic material.

In the exemplary embodiment shown in FIG. 20, a peeling unit 47 is attached to the spray head 19. At the end of a blade holder 49 attached to the spray head 19 in a height-adjustable fashion sits a blade 48 by means of which the excess ink may be scraped off of the bridges 4. This occurs with a rotary-driven printing image store 1 and a blade holder 49 that is displaceable parallel to the axis of the printing image store 1. The blade holder 49 can be displaced in this case with the aid of a rotating threaded spindle. The reference numeral 50 implies two compression springs that hold an end section of the blade holder 49, which carries the blade 48, in a position in an elastic fashion. The blade 48 is held on the end section of the Z-shaped blade holder 49 in an exchangeable fashion.

The peeling unit 47 described above is used in a final processing step after the printing image store 1 has been printed and dried. To this end, the sliding bed 11 as well as the roll carrier 12 are moved into the position shown in FIG. 20 and held there. A fixed stop may be provided for positioning purposes here as well. The blade 48 rests against the surface of the printing image store 1 with a certain initial tension, with the initial tension being maintained by the compression springs. By the simultaneous rotation of the printing image store 1 around its axis 2 and the linear displacement of the blade 48 by the rotation of the drive spindle, the blade 48 drags over a helical path on the surface of the printing image store 1 and scrapes off the remaining illustration material down to the height of the bridges.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for printing a surface of a flat or cylindrical printing image store that includes an arrangement of closely adjacent cells arranged in a screen shape that are separated from one another by bridges or a cylindrical printing substrate, the device comprising:
a carrier that carries the printing image store or the cylindrical printing substrate that is assigned to a stand in a displaceable fashion;
a coating unit assigned to the stand via which a protective layer and/or a primer is applied to the surface of the printing image store or the cylindrical printing substrate;
a printing unit assigned to the stand via which, using an ink jet printing head, ink is inserted into the cells at selected points on the surface of the printing image store or the cylindrical printing substrate;
a drying unit assigned to the stand via which the protective layer and/or primer applied to the surface of the printing image store or on the cylindrical printing substrate or the ink inserted into the cells or applied to the cylindrical printing substrate is dried; and
a positioning unit configured to move the carrier between the coating unit, the drying unit, and the printing unit and, at each place, to position the carrier in a processing position.

2. The device according to claim 1, wherein the carrier is equipped with bearing receptacles for accommodating an axis of the cylindrical printing image store or the cylindrical printing substrate and comprises a rotary drive that is driven by a servo motor for the cylindrical printing image store, via which the printing image store or cylindrical printing substrate is adapted to be rotated continuously or in predetermined angular stages.

3. The device according to claim 1, wherein the coating unit comprises a spray head that is moved transversely to the displacement direction of the carrier via a threaded spindle along a guide or guide rails in order to apply a protective layer and/or a primer to the printing image store or cylindrical printing substrate, which is moved forward step by step or continuously rotary-driven.

4. The device according to claim 1, wherein the ink jet printing head is moved transversely to a displacement direction of the carrier along a guide via a displacement drive.

5. The device according to claim 1, wherein the ink jet printing head comprises a plurality of nozzles arranged in a matrix pattern, wherein only such nozzles are involved in the printing process that are located nearest a section of the surface of the printing image store or cylindrical printing substrate facing the printing head.

6. The device according to claim 1, wherein the drying unit comprises a heat source, in particular an infrared heater, via which the printing image store or cylindrical printing substrate is heated to a drying or curing temperature, wherein the heat source is assigned to a hood that is configured to be lowered over the printing image store or cylindrical printing substrate.

7. The device according to claim 1, wherein a mechanical stop via which the carrier that is formed by a sliding bed and guided on a frame affixed to a stand is positioned in the printing unit.

8. The device according to claim 1, wherein the positioning unit comprises a geared belt drive or a spindle drive assigned to the frame, and wherein the sliding is affixed to the geared belt drive or the spindle drive.

9. The device according to claim 1, wherein the frame is adjustable in height by a lifting unit or is exchanged for another frame with a different height.

10. The device according to claim 1, further comprising a peeling unit to remove dried ink protruding past the bridges from the printing image store.

11. A method for printing a surface of a flat or cylindrical printing image store that includes an arrangement of cells disposed closely adjacent to one another in a screen shape that are separated from one another by bridges or cylindrical printing substrates, the method comprising:
mounting the printing image store or cylindrical printing substrate on a carrier assigned to a stand arranged in a displaceable fashion;
coating the surface of the printing image store or cylindrical printing substrate in a coating unit with a protective layer and/or a primer;
displacing the carrier to a drying unit;
drying the printing image store or cylindrical printing substrate by heating the printing image store or cylindrical printing substrate to a drying temperature;
displacing the carrier to a printing unit;
positioning the carrier in a predetermined printing position relative to the ink jet printing head of the printing unit;
inserting or applying ink line by line at selected points on the surface of the printing image store in the cells or on the cylindrical printing substrate;
displacing the carrier to the drying unit;
drying the ink filled into the cells; and
curing the ink filled into the cells.

12. The method according to claim 11, wherein the insertion of the ink into the cells or onto the cylindrical printing substrate and the subsequent drying are repeated long enough until the cells at the selected points are filled up to their edges with a solid contained in the ink or the desired amount of ink has been applied to the printing substrate.

13. The method according to claim 11, wherein, using the printing unit and in multiple consecutive process steps, ink is inserted into the cells at selected points on the surface of the printing image store or applied to the cylindrical printing substrate, with the ink being applied in a superimposed fashion.

14. The method according to claim 11, wherein an intermediate primer layer is applied between the individual printing steps.

15. The method according to claim 11, wherein during the coating of the surface of the cylindrical printing image store or printing substrate with the protective layer and/or the primer, the cylindrical printing image store or printing substrate is rotary driven around its axis in a continuous fashion and the spray head for applying the protective layer and/or the primer to the surface is moved evenly along the guide such that a helical strip of the protective layer and/or the primer is applied with edges overlapping.

16. The method according to claim 11, wherein the cylindrical printing image store or the cylindrical printing substrate have different diameters.

17. The method according to claim 11, wherein the cells are filled with different volumes or inks with different surface properties.

18. The method according to claim 11, wherein binary surface-variable or depth and binary surface-variable gravure printing forms and offset printing forms are produced.

19. A method for producing gravure printing forms and offset printing forms, the method comprising:
inserting ink into approximately uniform cells of a printing image store arranged in a screen-like fashion via an ink jet printing head;
applying a primer before the insertion of the ink to the surfaces of the cells, the primer influencing an interfacial tension and/or flow properties and/or fluidity of the ink.

20. The device according to claim 1, wherein the ink is water-based.
